(19) United States
(12) Patent Application Publication
(10) Pub. No.: US 2009/0242099 A1
(43) Pub. Date: Oct. 1, 2009

(54) METHOD OF PRODUCING A PIEZOSTACK DEVICE

(75) Inventors: Toshiatsu NAGAYA, Kuwana-shi (JP); Masaya Nakamura, Nagoya (JP); Daisuke Shibata, Tokai-shi (JP); Kouji Noda, Nukata-gun (JP); Masatoshi Ikeda, Hazu-gun (JP)

Correspondence Address: NIXON & VANDERHYE, PC, 901 NORTH GLEBE ROAD, 11TH FLOOR, ARLINGTON, VA, 22203, US

(73) Assignees: DENSO CORPORATION, Kariya-city (JP); NIPPON SOKEN, INC., Nishio-city (JP)

(21) Appl. No.: 12/414,864

(22) Filed: Mar. 31, 2009

(30) Foreign Application Priority Data
Mar. 31, 2008 (JP) 2008-090394

(51) Int. Cl. C03B 29/00

(52) U.S. Cl. 156/89.12

(57) ABSTRACT

A method of producing a piezostack device including multiple piezoelectric ceramic layers of a crystal-orientated ceramic and multiple electrode-containing layers laminated alternately. A raw material mixture is prepared in the mixing step, as an anisotropically shaped powder of oriented particles and a reactive raw powder are mixed. The anisotropically shaped powder and the reactive raw powder are then mixed in amounts at a stoichiometric ratio giving an isotropic perovskite compound, and a Nb₂O₅ powder and/or a Ta₂O₅ powder were added thereto. The raw material mixture is molded into a sheet shape in the sheet-forming step, while the crystal faces of the anisotropically shaped powder particles are almost oriented. An electrode material is printed on the green sheet in the printing step. The green sheets obtained after the printing step are laminated in the laminating step. The composite thus obtained is sintered in the sintering step, to give a piezostack device.

### CROSS REFERENCE TO RELATED DOCUMENT

The present application claims the benefit of Japanese Patent Application No. 2008-90394 filed on Mar. 31, 2008, the disclosure of which is incorporated herein by reference.

### BACKGROUND OF THE INVENTION

1. Technical Field of the Invention

The present invention relates to a method of producing a piezostack device having multiple piezoelectric ceramic layers and multiple electrode-containing layers laminated alternately laminate.

2. Background Art

A piezostack device of piezoelectric ceramic layers of a piezoelectric material expandable/shrinkable by application of voltage and electrode-containing layers containing electrode regions constituting internal electrodes laminated alternately laminate is already known (see JP-A-2007-258280). There is a demand for improvement in the displacement amount of the piezostack device and various piezoelectric materials have been developed. In particular, recently, there is a need for development of non-lead-containing piezoelectric materials, for reduction of the adverse effects on environment.

However, non-lead-containing piezoelectric materials were lower in piezoelectric properties than lead-based piezoelectric materials, and piezostack devices using such a piezoelectric material unfavorably could not show sufficiently favorable displacement characteristics.

Thus, piezoelectric ceramics compositions of a KNN-based perovskite compound were developed (see JP-B-3945536). It would be possible to improve the displacement amount of the piezostack devices by using such a piezoelectric material.

However, there is recently a need for piezostack device superior displacement characteristics, and there is still no sufficiently favorable piezostack device prepared by using a conventional piezoelectric ceramics composition.

Reference 1: JP-A-2007-258280

Reference 2: JP-B-3945536

An object of the present invention, which was made under the circumstances above, is to provide a method of producing a piezostack device showing favorable displacement characteristics.

### SUMMARY OF THE INVENTION

The present invention is a method of producing a piezostack device having piezoelectric ceramic layers of an crystal-oriented ceramic of polycrystals containing an isotropic perovskite compound as the main phase, in which the crystal faces {100} of the crystal grains constituting the polycrystals are oriented, and electrode-containing layers containing electrode regions constituting internal electrodes laminated alternately, including:

a mixing step of mixing an anisotropically shaped powder only of anisotropically shaped orientation particles, of which the crystal faces {100} are to be oriented, and a reactive raw powder giving the isotropic perovskite compound in reaction with the anisotropically shaped powder, to give a raw material mixture;

a sheet-forming step of molding the raw material mixture into a sheet shape, so that the crystal faces {100} of the anisotropically shaped powder particles are oriented almost unidirectionally to give a green sheet;

a printing step of printing the electrode region on the green sheet after sintering thereof with an electrode material;

a laminating step of laminating the green sheets after the printing step into a laminate sheet; and

a sintering step of obtaining the piezostack device having piezoelectric ceramic layers of the crystal-oriented ceramic and the electrode-containing layers containing the electrode regions laminated alternately by allowing reaction between the anisotropically shaped powder and the reactive raw powder and sintering the mixture by heating the laminate sheet, wherein,

in the mixing step, the anisotropically shaped powder and the reactive raw powder are mixed in amounts at a stoichiometric ratio giving an isotropic perovskite compound represented by General Formula (1): {Liₓ(K_{1-y}Na_{y})₁₋ₓ}ₐ(Nb_{1-z-w}Ta_{z}Sb_{w})O₃, (wherein, 0≦x≦0.2, 0≦y≦1, 0≦z≦0.4, 0≦w≦0.2, x+z+w>0, and 0.95≦a≦1) from the anisotropically shaped powder and the reactive raw powder after the sintering step, and a Nb₂O₅ powder and/or a Ta₂O₅ powder are mixed in an addition amount of 0.005 to 0.02 mole with respect to 1 mole of the isotropic perovskite compound represented by the General Formula (1).

In the production method according to the present invention, a piezostack device is produced by processing in mixing, sheet-forming, printing, laminating and sintering steps.

In the mixing step, a raw material mixture containing the anisotropically shaped powder and the reactive raw powder is prepared by mixing the anisotropically shaped powder with the reactive raw powder.

In the sheet-forming step, the raw material mixture is molded into a sheet shape, so that the {100} faces of the anisotropically shaped powder particles are oriented almost unidirectionally. A green sheet in which the {100} faces of the anisotropically shaped powder particles are oriented almost unidirectionally can be prepared in this way.

Subsequently the electrode material is printed on the green sheet in the printing step, and a laminate sheet is prepared by laminating the green sheets in the laminating step, thus, giving a laminate sheet containing multiple green sheets above carrying printed electrode materials.

The laminate sheet is heated in the sintering step. It is possible in this way to in the green sheet of the laminate sheet form a piezoelectric ceramic layer of the crystal-oriented ceramic by allowing reaction of the anisotropically shaped powder with the reactive raw powder and sintering the composite and form the electrode region in the region where the electrode material is printed. In the sintering step, the anisotropically shaped powder oriented almost unidirectionally react with the surrounding reactive raw powder in the green sheet, forming the piezoelectric ceramic layer of the crystal-oriented ceramic in which the {100} faces of the crystal grains are oriented.

In this way, the piezostack device having piezoelectric ceramic layers of a crystal-oriented ceramic are superior in displacement characteristics to the piezostack device having non-oriented piezoelectric ceramic layers.

Also in the mixing step according to the present invention, the anisotropically shaped powder and the reactive raw powder are mixed in amounts at a stoichiometric ratio giving an isotropic perovskite compound represented by the General Formula (1), and a Nb₂O₅ powder and/or a Ta₂O₅ powder are mixed in an addition amount of 0.005 to 0.02 mole with respect to 1 mole of the isotropic perovskite compound.

It is thus possible, by using the raw material mixture containing the Nb₂O₅ powder and/or the Ta₂O₅ powder in the certain amount, to raise the orientation degree of the crystal-oriented ceramic, compared to the case where no Nb₂O₅ powder or Ta₂O₅ powder is added. It is thus possible to improve the displacement characteristics of the piezostack device further.

The reasons would be the followings:

The crystal-oriented ceramic is formed by generation of crystal oriented particles by reaction and sintering of the anisotropically shaped powder with the surrounding reactive raw powder and sintering of the particles in the sintering process. In addition, the crystal-oriented ceramic is sintered at a temperature higher than solidus, and the reactive raw powder is considered to be in the semi-molten state (mixed liquid- and solid-phase) during sintering. If the amount of the liquid phase is larger then, the orientation of the anisotropically shaped powder seems to be disturbed by the driving force for sintering, leading to deterioration in crystal orientation degree of the sintered body. Accordingly, it would be possible to improve the crystal orientation degree by reducing the amount of the liquid phase. Because the liquid phase contains alkali metal elements, addition of an element that solidifies in reaction with the alkali metal elements would reduce the liquid phase content.

The inventors have found that it was possible to reduce the liquid phase content by adding the anisotropically shaped powder, the reactive raw powder and additionally a Nb₂O₅ powder and/or a Ta₂O₅ powder in the mixing step. The Nb₂O₅ powder and/or the Ta₂O₅ powder, which react directly with the liquid phase generated in the sintering process, showing an action to reduce the liquid phase content, would suppress the turbulence of the orientation of the anisotropically shaped powder and thus improve the orientation degree as described above.

In particular, Nb becomes the main element component in the General Formula (1) above and thus, the change in composition by addition of the Nb₂O₅ powder would be small.

In addition, addition of the Nb₂O₅ powder and/or the Ta₂O₅ powder may alter the ratio of A site to B site (A/B) in the perovskite compound (ABO₃). For that reason, the improvement in crystal orientation degree by addition of the Nb₂O₅ powder and/or the Ta₂O₅ powder may be considered to be caused by the change in the A/B ratio, but, as will be described below in Examples, addition of the Nb₂O₅ powder and/or the Ta₂O₅ powder in such a manner that the A/B ratio remains constant does provide the action to improve the orientation degree. Therefore, the improvement in orientation degree is considered to be due to the addition of the Nb₂O₅ powder and/or the Ta₂O₅ powder.

Even if the Nb₂O₅ powder and/or the Ta₂O₅ powder are added in the amount above, there is no significant influence on the sintering efficiency, and thus, the piezoelectric ceramic layer of the crystal-oriented ceramic can be formed almost without any deterioration in density in the sintering step.

It is also possible in the present invention to form a piezoelectric ceramic layer of a {100} face-oriented crystal ceramic and such a piezoelectric ceramic layer has a favorable piezoelectric d constant and shows favorable displacement characteristics.

As described above, the present invention provides a method of producing a piezostack device showing favorable displacement characteristics.

### BRIEF DESCRIPTION OF THE DRAWINGS

FIG. 1(A) is an explanatory view illustrating an entire configuration of a piezostack device of Example 1;

FIG. 1(B) is an explanatory view illustrating a cross section of a piezostack device of Example 1 in a lamination direction;

FIG. 2(A) is an explanatory view illustrating an entire configuration of a piezostack device of Example 1 having counter electrodes formed on both end face in a lamination direction;

FIG. 2(B) is an explanatory view illustrating a cross section of a piezostack device of Example 1 having counter electrodes formed on both end faces in a lamination direction; and

FIG. 3 an explanatory view illustrating a cross section of a piezostack device of Example 3 in a lamination direction.

### DESCRIPTION OF THE PREFERRED EMBODIMENTS

Hereinafter, preferred embodiments of the present invention will be described.

In the present invention, a piezostack device having the piezoelectric ceramic layer and the electrode-containing layers laminated alternately to each other is produced by the processing in mixing, sheet-forming, printing, laminating and sintering steps above.

The piezoelectric ceramic layer is made of a crystal-oriented ceramic of polycrystals containing an isotropic perovskite compound in the main phase, wherein the crystal faces {100} of the crystal grains constituting the polycrystal are oriented.

As used herein, the term “isotropic” indicates that if the perovskite structure ABO₃ is expressed by pseudocubic primitive lattice, the relative ratios of the axial lengths a, b and c are in the range of 0.8 to 1.2 and the axial angles α, β and γ are in the range of 80 to 1000. The crystal face is the pseudocubic {100} face.

As used herein, the term “crystal face {100} is oriented” means that crystal grains are aligned in such a manner that the {100} faces of the perovskite compound particles become in parallel with each other (hereinafter, such a state will be referred to as “face-orientated”).

As used herein, the term “pseudocubic {HKL}” means that, although common isotropic perovskite compounds have a structure slightly distorted from tetragonal, orthorhombic, trigonal or cubic structure, it is regarded as cubic and expressed with Miller indices, because the deformation is only slight.

When a particular crystal face is face-oriented the degree of face orientation can be expressed with the average orientation degree F (HKL), which is represented by Numerical Formula 1 by the Lotgering method.

$$F ( HKL ) = \frac{\frac{{Σ}^{′} I ( HKL )}{Σ I ( hkl )} - \frac{{Σ}^{′} {I}_{0} ( HKL )}{Σ {I}_{0} ( hkl )}}{1 - \frac{{Σ}^{′} {I}_{0} ( HKL )}{Σ {I}_{0} ( hkl )}} \times 100 ( \% ) \qquad [ Numerical Formula 1 ]$$

In Numerical Formula 1, ΣI(hkl) is the total sum of the X-ray diffraction intensities on all crystal faces (hkl) determined of the crystal-oriented ceramic; and ΣI₀(hkl) is the total sum of the X-ray diffraction intensities on all crystal faces (hkl) determined of a non-oriented piezoelectric ceramic having the same composition as the crystal-oriented ceramic. Alternatively, Σ′I(HKL) is the total sum of the X-ray diffraction intensities on crystallographically equivalent particular crystal faces (HKL) measured of the crystal-oriented ceramic, and Σ′I₀(HKL) is the total sum of the X-ray diffraction intensities on crystallographically equivalent particular crystal faces (HKL) measured of a non-oriented piezoelectric ceramics having the same composition as the crystal-oriented ceramic.

Therefore, when the crystal grains constituting the polycrystal are un-oriented, the average orientation degree F (HKL) is 0%. Alternatively when the (HKL) faces of all crystal grains constituting the polycrystal are oriented in parallel with the measuring face, the average orientation degree F (HKL) is 100%.

In the crystal-oriented ceramic above, increase in the number of oriented crystal grains leads to improvement in properties.

In the mixing step above, a raw material mixture is prepared by mixing the anisotropically shaped powder, the reactive raw powder, and the Nb₂O₅ powder and/or the Ta₂O₅ powder.

As used in the present invention, the term “anisotropic shape” means that the dimension in the longitudinal direction is larger than that in the width or thickness direction. Preferred typical examples thereof include plate-shaped, columnar, scaly, spicular and other shapes.

The orientation particle preferably has a shape permitting easy orientation in a particular direction during processing in the sheet-forming step. For the reasons the orientation particle preferably has an average aspect ratio of 3 or more. An average aspect ratio of less than 3 makes it difficult to orient the anisotropically shaped powder unidirectional in the sheet-forming step described below. The aspect ratio of the orientation particle is preferably 5 or more, for production of the crystal-oriented ceramic with higher orientation degree. The average aspect ratio is an average of the value maximum dimension/minimum dimension of the orientation particles.

Increase in the average aspect ratio of the orientation particle likely makes it easier to orient the orientation particles in the sheet-forming step. However, an excessively large average aspect ratio may lead to breakdown of the orientation particles in the mixing step. As a result, there is a concern about the orientation particles not giving a molded article in the sheet-forming step. For that reason, the average aspect ratio of the orientation particles is preferably 100 or less, more preferably 50 or less, and still more preferably 30 or less.

Also in the sintering step, in which crystal grains are formed in reaction between the anisotropically shaped powder and the reactive raw powder by sintering, excessively large orientation particles of the anisotropically shaped powder may unfavorably lead to growth of the crystal grains and deterioration in strength of the crystal-oriented ceramic obtained. Accordingly, the maximum dimension of the orientation particle in the longitudinal direction is preferably 30 μm or less, more preferably 20 μm or less, and still more preferably 15 μm or less. Alternatively, an excessively small orientation particle may lead to reduction of the crystal grains and deterioration in the piezoelectric performance of the resulting crystal-oriented ceramic. Therefore, the maximum dimension of the orientation particle it the longitudinal direction is preferably 0.5 μm or more, more preferably 1 μm or more, and still more preferably 2 μm or more.

In the mixing step, the anisotropically shaped powder and the reactive raw powder are mixed in the stoichiometric amounts giving an isotropic perovskite compound represented by General Formula (1): {Liₓ(K_{1-y}Na_{y})₁₋ₓ}ₐ(Nb_{1-z-w}Ta_{z}Sb_{w})O₃, (wherein, 0≦x≦0.2, 0≦y≦1, 0≦z≦0.4, 0≦w≦0.2, x+z+w>0, and 0.95≦a≦1.05) in the sintering step.

In the General Formula (1), “x+z+w>0” means that at least one of Li, Ta and Sb is included as the substitution element.

If the compound represented by the General Formula (1) is expressed by Formula ABO₃ of the composition of perovskite structure, the component ratio of the A site atom to the B site atom may be 1.1 respectively with ±5% possible deviation. It is preferably with ±3% possible deviation, for further reduction of the lattice defects in the final crystal—oriented ceramic and improvement of the piezoelectric properties. Thus in the General Formula, 0.95≦a≦1.05, preferably 0.97≦a≦1.03.

In the composition of the actual isotropic perovskite compound (ABO₃) after sintering of the mixture of the anisotropically shaped powder and the reactive raw powder and additionally the Nb₂O₅ powder and/or the Ta₂O₅ powder, the ratio A/B of the A site element to B site element is preferably 0.94 to 1. If the ratio is less than 0.94, there is a concern about generation of heterogeneous phase and deterioration of the orientation degree. Alternatively if it is more than 1, there is a concern about segregation of the alkali metal components on the grain boundary, leading to deterioration of the insulation resistance. For that reason, as described above, it is desirable in the mixing step to mix the anisotropically shaped powder and the reactive raw powder in such amounts that a in the General Formula (1) falls in the range of 0.95≦a≦1.05, more preferably 0.97≦a≦1.03.

Also in the General Formula (1), “y” represents the ratio of K to Na contained in the isotropic perovskite compound. The compound represented by the General Formula (a) may contain at least one element, K or Na, as the A site element.

The range of y in the General Formula (1) above is more preferably 0≦y≦1.

In such a case, Na is the essential component in the compound represented by the General Formula (1). Thus in this case, it is possible to improve the piezoelectric properties such as piezoelectric g₃₁ constant of the crystal-oriented ceramic.

The range of y in the General Formula (1) may be 0≦y≦1. In this case, K is the essential component in the compound represented by the General Formula (1). Thus in this case; it is possible to improve the piezoelectric properties such as piezoelectric d constant of the crystal-oriented ceramic and produce a piezostack device superior in displacement characteristics. Because increased addition of K allows sintering at lower temperature in this case, it is possible to produce the piezostack device at low energy and low cost.

In the General Formula (1), y is preferably in the range of 0.05≦y≦0.75, more preferably 0.20≦y≦0.70. In such a case, it is possible to improve the piezoelectric d₃₁ constant and the electromechanical coupling factor Kp of the crystal-oriented ceramic further. It is more preferably in the range of 0.20≦y≦0.70, still more preferably 0.35≦y≦0.65, and still more preferably 0.35≦y≦0.65. It is most preferably 0.42≦y≦0.60.

“x” represents the substitution amount of Li substituting the A site elements K and/or Na. Substitution of part of K and/or Na with Li leads to improvement in piezoelectric properties and others, raising the Curie temperature and/or accelerating densification.

The range of x in the General Formula (1) is more preferably 0≦x≦0.2.

In this case, Li is the essential component in the compound represented by the General Formula (1), and thus, it is possible to sinter the crystal-oriented ceramic more easily in the sintering step, improve the piezoelectric properties further, and raise the Curie temperature (Tc) further. Li, when present as the essential component in the range of x above, allows reduction of sintering temperature and thus permits pore-less sintering, while Li serving as a sintering assistant.

A x value of more than 0-2 may lead to deterioration in piezoelectric properties (piezoelectric d₃₁ constant, electromechanical coupling coefficient kp, piezoelectric g₃₁ constant, etc.).

x in the General Formula (1) may be 0.

In this case, the General Formula (1) is represented by (K_{1-y}Na_{y})ₐ(Nb_{1-z-w}Ta_{z}Sb_{w})O₃. In this case, because the raw materials do not include compounds containing the lightest metal element Li such as LiCO₃ during preparation of the crystal-oriented ceramic, it is possible to reduce fluctuation in characteristics by segregation of the raw material powder during mixing of the raw materials. Also in this case, the crystal-oriented ceramic can exhibit a high dielectric constant and a relatively large piezoelectric g constant. In the General Formula (1), x is preferably in the range of 0≦x≦0.15, more preferably 0≦x≦0.10.

“z” represents the substitution amount of Ta substituting the B site element Nb. Substitution of part of Nb with Ta leads to improvement in piezoelectric properties. In the General Formula (1), a z value of more than 0.4 may lead to decrease of the Curie temperature of the crystal-oriented ceramic, making it difficult to apply the resulting piezostack device as a part in home appliances and automobiles.

The range of z in the General Formula (1) is preferably 0<z≦0.4.

In this case, Ta is the essential component in the compound represented by the General Formula (1). Thus in this case, presence of Ta leads to reduction of the sintering temperature and reduces the number of pores in the crystal-oriented ceramic, while Ta serving as a sintering aid.

z in the General Formula (1) may be 0.

In this case, the General Formula (1) is represented by: {Liₓ(K_{1-y}Na_{y})₁₋ₓ}ₐ(Nb_{1-w}Sb_{w})O₃, and the compound represented by the General Formula (1) contains no Ta. Thus in this case, the compound represented by the General Formula (1) shows superior piezoelectric properties, even if it is produced without use of an expensive Ta component.

The range of z in the General Formula (1) is preferably 0≦z≦0.35, more preferably 0≦z≦0.30.

“w” represents the substitution amount of Sb substituting the B site element Nb. Substitution of part of Nb with Sb leads to improvement in piezoelectric properties and others. A w value of more than 0.2 unfavorably leads to deterioration in piezoelectric properties and/or lowering of the Curie temperature.

The range of w in the General Formula (1) is preferably 0<w≦0.2.

In this case, Sb is the essential component in the compound represented by the General Formula (1). Thus in this case, presence of Sb leads to reduction of sintering temperature, improvement in sintering efficiency, and also improvement in stability of dielectric loss tan δ of the crystal-oriented ceramic.

w in the General Formula (1) may be 0. In this case, the General Formula (1) is represented by: {Liₓ(K_{1-y}Na_{y})₁₋ₓ}ₐ(Nb_{1-z}Ta_{z})O₃, and the compound represented by the General Formula (1) does not contain Sb and can show a relatively high Curie temperature. The range of w in the General Formula (1) is preferably 0≦w≦0.15, more preferably 0≦w≦0.10.

When cooled from high temperature to low temperature, the crystalline phase of the crystal-oriented ceramic changes in the order of: cubic to tetragonal (first crystalline phase-transition temperature: Curie temperature), tetragonal to orthorhombic (second crystalline phase-transition temperature), and orthorhombic to rhombohedral (third crystalline phase-transition temperature). In the temperature region higher than the first crystalline phase-transition temperature, the crystalline phase is cubic and the displacement characteristics disappears, while, in the temperature region lower than the second crystalline phase-transition temperature, the crystalline phase is orthorhombic, and the displacement and the apparent dynamic electrostatic capacity become more temperature-dependent. It is thus preferable to make the crystalline phase tetragonal over the entire operating temperature range, by making the first crystalline phase-transition temperature higher than the operating temperature range and the second crystalline phase-transition temperature lower than the operating temperature range.

According to “Journal of American Ceramic Society, U.S., 1959, Vol, 42 [9], p. 438-442, and U.S. Pat. No. 2,976,246, the crystalline phase of the basic composition of the crystal-oriented ceramic, i.e., potassium sodium niobate (K_{1-y}Na_{y}NbO₃), changes, as it is cooled from high temperature to low temperature, in the order: cubic to tetragonal (first crystalline phase-transition temperature: Curie temperature), tetragonal to orthorhombic (second crystalline phase-transition temperature), and orthorhombic to rhombohedral (third crystalline phase-transition temperature). The first crystalline phase-transition temperature when “y=0.5” is approximately 420° C., the second crystalline phase-transition temperature, approximately 190° C., and the third crystalline phase-transition temperature, approximately −150° C. Accordingly, the tetragonal temperature region is in the range of 190 to 420° C., which is not in accord with the operating temperature range for common industrial products of −40 to 160° C.

On the other hand, in the case of the crystal-oriented ceramic above, it is possible to change the first and second crystalline phase-transition temperatures arbitrarily by modifying the amount of the substitution elements such as Li, Ta and Sb in the basic composition of potassium sodium niobate (K_{1-y}Na_{y}NbO₃).

The results of multi-regression analysis between the substitution amounts of Li, Ta and Sb and the actual crystalline phase-transition temperature, when y is 0.4 to 0.6, at which the piezoelectric properties are greatest, are shown in the following Formulae B1 and B2.

Formulae B1 and B2 show that increase in Li substitution leads to heightening of the first crystalline phase-transition temperature but lowering of the second crystalline phase-transition temperature. Ta and Sb substitution have actions to lower the first crystalline phase-transition temperature and also of the second crystalline phase-transition temperature.

First crystalline phase-transition temperature=(388+9x−5z−17w)±50[° C.] (Formula B1)

Second crystalline phase-transition temperature=(190−18.9x−3.9z−5.8w)±50[° C.] (Formula B2)

The first crystalline phase-transition temperature is a temperature at around which the piezoelectricity disappears completely and the dynamic capacity becomes significantly larger and is thus preferably a temperature of +60° C. or more higher than the maximum uses environment temperature of a product. The second crystalline phase-transition temperature is simply a temperature at which the crystalline phase transition occurs, and, because the piezoelectricity does not disappear and thus, only the temperature dependence of displacement or dynamic capacity is desirably adjusted not to be affected by the temperature, it is preferably +40° C. or less higher than the minimum use environment temperature of a product.

On the other hand, the maximum use environment temperature of the product varies, for example, at 60° C., 80° C., 100° C., 120° C., 140° C., or 160° C., depending on its application. The minimum use environment temperature of the product is, for example, −30° C. or −40° C.

The first crystalline phase-transition temperature shown in the Formula B1 is desirably 120° C. or higher, and thus, “x”, z and w preferably satisfy the equation (388+9x−5z−17w)+50≧120.

The second crystalline phase-transition temperature shown in Formula B2 is desirably 10° C. or lower, and thus, “x”, “z” and “w” preferably satisfy the equation (190−18.9x−3.9z−5.8w)−50≦10.

Thus in the General Formula (1), the equations of 9x−5z−17w≧−318, and −18.9x−3.9z−5.8w≦−130 are preferably satisfied at the same time.

The anisotropically shaped powder is preferably an acid hydrolysate obtained by acid treatment of an anisotropically shaped starting material of a bismuth layered perovskite compound represented by General Formula (2): (Bi₂O₂)²⁺{Bi_{0.5}(KᵤNa₁₋ᵤ)ₘ₋1.5(Nb₁₋ᵥTaᵥ)ₘO₃ₘ₊₁}²⁻ (wherein, m is an integer of 2 or more, 0≦u≦0.8, and 0≦v≦0.4).

It is possible in this case to reduce deterioration in density and also to improve the orientation of the crystal-oriented ceramic. In other words, although decrease in the amount of liquid phase by addition of Nb₂O₅ powder and/or Ta₂O₅ powder may lead to improvement in orientation degree of the crystal-oriented ceramic but also to increased difficulty in sintering the crystal-oriented ceramic, the acid hydrolysate, which contains more A site defects (alkali metal element defects) and is thus more reactive with the liquid phase containing the reaction raw material-derived alkali metal element during sintering, allows improvement in sintering efficiency. It is thus possible to produce the piezostack device more superior in displacement characteristics.

For example in forming a crystal-oriented ceramic by using a plate-shaped powder of NaNbO₃ as the anisotropically shaped powder, the plate-shaped powder may be disoriented during molding, because the surface of plate-shaped powder surface is roughened. In contrast, if the acid hydrolysate is used as the anisotropically shaped powder, the surface of the plate-shaped powder is smooth, allowing improvement in orientation during molding. It is thus possible to improve the orientation degree of the crystal-oriented ceramic further.

When u in General Formula (2) is more than 0.8, the melting point the anisotropically shaped powder decreases, possibly making it difficult to form a crystal-oriented ceramic with high orientation degree in the sintering step. On the other hand, when v is more than 0.4, the Curie temperature of the crystal-oriented ceramic declines, possibly making it difficult to use the piezostack device as a part used in home appliances and automobiles. Alternatively if m is too large, the anisotropically shaped powder of the bismuth layered perovskite compound may possibly be produced with some non-anisotropically shaped perovskite fine particles during synthesis. Thus for improvement of the yield of the anisotropically shaped particles, m is preferably an integer of 15 or less.

The acid treatment can be carried out by bringing the starting material in contact with an acid such as hydrochloric acid.

Specifically, for example, the starting raw powder is mixed in an acid under heat.

The reactive raw powder may be selected from powders that give a desired isotropic perovskite compound in reaction with the anisotropically shaped powder when sintered with the anisotropically shaped powder.

The reactive raw powder preferably has a particle diameter of ⅓ or less of that of the anisotropically shaped powder.

If the particle diameter of the reactive raw powder is larger than ⅓ of the anisotropically shaped powder particle diameter, it may become difficult in the sheet-forming step, to mold the raw material mixture so that the {100} faces of the anisotropically shaped powder particles are oriented almost unidirectionally. It is more preferably ¼ or less and yet more preferably ⅕ or less.

The particle diameter of the reactive raw powder and that of the anisotropically shaped powder can be compared by comparing the average particle diameter of the reactive raw powder with that of the anisotropically shaped powder. The particle diameter above of the anisotropically shaped powder and that of the reactive raw powder are those of the largest diameter.

The composition of the reactive raw powder can be determined according to the desired composition of the anisotropically shaped powder, and the composition of the isotropic perovskite compound represented by the General Formula (1). Examples of the reactive raw powder for use include oxide powders, mixed oxide powders, hydroxide powders, salts such as carbonate salts, nitrate salts and oxalate salts, alkoxides and the like.

Examples of the reactive raw powders include one or more calcined powder selected from powders of Li sourced source, Na source Nb source, Ta source, and Sb source. Each element source described above may be a compound containing at least one or more of these elements. The blending ratio of each element source can be determined according to the composition of the perovskite compound represented by the General Formula (1) and the composition of the anisotropically shaped powder.

The reactive raw powder is preferably a powder of an isotropic perovskite compound represented by General Formula (3): {Liₚ(K_{1-q}Na_{q})₁₋ₚ}_{c}(Nb₁₋ᵣ₋ₛTaᵣSbₛ)O₃, (wherein, 0≦p≦1, 0≦q≦1, 0≦r≦1, 0≦s≦1, and 0.95≦c≦1.05).

In this case, it is possible to form a high-density high-orientation crystal-oriented ceramic easily.

Also in the General Formula (3), if the compound represented by the General Formula (3) is expressed by Formula ABO₃ of the composition of perovskite structure, the component ratio of the A site atom to the B site atom may be 1:1 respectively with ±5% possible deviation. The component ratio is preferably with ±3% possible deviation, for further reduction of the lattice defects in the final crystal-oriented ceramic and improvement of the piezoelectric properties. Thus in the General Formula (3), preferably 0.95≦c≦1.05, and more preferably 0.97≦c≦1.03.

Also in the General Formula (3), similarly to the General Formula (1), the equations 9p−q−17s≧−318, and −18.9p−3.9r−5.8s≦−130 are preferably satisfied.

In the mixing step, the anisotropically shaped powder and the reactive raw powder are blended in amounts at stoichiometric to the Formula represented by the General Formula (1). The blending ratio (molar ratio) of the anisotropically shaped powder to the reactive raw powder then is preferably (0.02 to 0.10) to (0.98 to 0.90) (with respect to 1 of the total of the anisotropically shaped powder and the reaction raw material).

In the blending ratio (molar ratio) above, if the ratio of the anisotropically shaped powder is less than 0.02 or that of the reactive raw powder more than 0.98, it may be possible to obtain improvement in orientation degree by addition of Nb₂O₅ powder and/or Ta₂O₅ powder, but may not be possible to raise the orientation of the crystal-oriented ceramic to the practically sufficient level.

On the other hand, if the ratio of the anisotropically shaped powder is more than 0.10 or that of the reactive raw powder less than 0.90, it may not be possible to form a high-density crystal-oriented ceramic.

The Nb₂O₅ powder and/or the Ta₂O₅ powder are added additionally in the mixing step in an addition amount of 0.005 to 0.02 mole, with respect to 1 mole of the anisotropically shaped powder and the isotropic perovskite compound represented by the General Formula (1) generated from the reactive raw powder. If both the Nb₂O₅ and Ta₂O₅ powders are used, these powders are added in a total amount of 0.005 to 0.02 mole with respect 1 mole of the isotropic perovskite compound represented by the General Formula (1).

If the addition amount of Nb₂O₅ powder and/or Ta₂O₅ powder is less than 0.005 mole, it may not be possible to obtain the favorable effect of improving orientation degree described above by addition of the Nb₂O₅ powder and/or the Ta₂O₅ powder On the other hand, if it is more than 0.02 mole, there is rather concern about deterioration in the orientation degree. More preferably, the addition amount of the Nb₂O₅ powder and/or the Ta₂O₅ powder is preferably 0.015 mole or less with respect to 1 mole of the isotropic perovskite compound represented by the General Formula (1).

The Nb₂O₅ powder and the Ta₂O₅ powder may constitute part of the component elements in the isotropic perovskite compound after sintering. Thus, the composition of the crystal-oriented ceramic after the sintering step is considered to be deviated in practice from the desired compositions of the anisotropically shaped powder and the reactive raw powder in the mixing step, by the addition amount of the Nb₂O₅ powder and/or the Ta₂O₅. In the present invention, the composition represented by the General Formula (1) in the mixing step is a composition determined only from the anisotropically shaped powder and the reactive raw powder with the addition of the Nb₂O₅ powder and the Ta₂O₅ powder not being taken into consideration, and in the mixing step, certain amounts of the Nb₂O₅ powder and/or the Ta₂O₅ powder are added with respect to 1 mole of the composition as described above.

Preferably in the mixing step, only the Nb₂O₅ powder, of the Nb₂O₅ and Ta₂O₅ powders, is preferably added.

It is possible in this case to reduce the change in composition of the perovskite compound by addition of the additive.

In the mixing step, the anisotropically shaped powder, the reaction raw material, the Nb₂O₅ powder and the Ta₂O₅ powder may be mixed in the dry condition or in the wet condition with an added suitable dispersion medium such as water or alcohol. One or more additives selected from birders, plasticizers, and dispersants and others may be added then as needed.

Then in the sheet-forming step, the raw material mixture is molded into a sheet shape, giving a green sheet, for orientation of the crystal faces {100} of the anisotropically shaped powder particles almost unidirectionally.

The molding method is not particularly limited, if it can orient the anisotropically shaped powder. Typical preferable examples of the molding methods for face orientation of the anisotropically shaped powder include doctor blade method, press molding method, rolling method, and the like. The anisotropically shaped powder can be oriented almost unidirectionally in the molding, for example, by the shearing stress applied to the anisotropically shaped powder by these molding methods.

Then in the printing step, an electrode material for the electrode region is printed on the green sheet after sintering.

The electrode material for use may be, for example, a paste-state Ag/Pd alloy. Alternatively a metal such as Ag, Pd, Cu, or Ni or an alloy such as of Cu/Ni may be used.

Such an electrode material can be printed in a desired region corresponding to the electrode region on the green sheet after sintering.

Specifically, the electrode material may be printed thereon so that a full-area electrode is formed between piezoelectric ceramic layers in a piezostack device after sintering or local electrodes are formed between the piezoelectric ceramic layers. If local electrodes are desirably formed, the electrode material is printed on the desired regions of the green sheet, as part of the electrode regions recede from the side walls of the piezostack device, so that non-electrode-formed regions are formed.

In the laminating step, the green sheets after the printing step are laminated into a laminate sheet.

Green sheets without printed electrode material may be placed at both ends of the laminated sheet in the lamination direction as needed. It is possible in this way to obtain after sintering piezostack device dummy layers of crystal-oriented ceramic connected to both ends thereon in the lamination direction. One or more layers of the green sheet for forming the dummy layer may be formed at both ends of the laminate sheet in the lamination direction.

It is also possible to bond the green sheet to the electrode material under pressure by pressurizing the laminate sheet after the laminating step in the lamination direction. The bonding may be carried out by so-called thermocompression bonding in which the composite is pressurized under heat.

In addition, the laminate sheet may be degreased before sintering for removal of organic components such as binder.

The piezostack device, having of the piezoelectric ceramic layers of the crystal-oriented ceramic and the electrode-containing layers containing the electrode regions laminated alternately, is prepared by allowing reaction of the anisotropically shaped powder with the reactive raw powder by heating the laminate sheet and sintering it in the sintering step. In the sintering step, heat treatment of the laminate sheet leads to acceleration of the reaction between the anisotropically shaped powder and the reaction raw material and also the sintering of the composite, giving the piezoelectric ceramic layer made of the crystal-oriented ceramic of polycrystals containing the isotropic perovskite compound as the main phase. It is also possible to form electrode regions constituting internal electrodes in the electrode material-formed region.

A temperature most favorable may be selected according to the anisotropically shaped powder and the reaction raw material used, and the composition of the crystal-oriented ceramic to be prepared as the heating temperature in the sintering step, for efficient progress of the reaction and/or the sintering and for production of a reaction product having a desired composition. Specifically, for example, the processing may be carried out at a temperature of 900° C. to 1300° C.

A pair of external electrodes of conductive metal such as of Ag may be formed on the external peripheral surface wall of the piezostack device. The pair of external electrodes may be electrically connected to the multiple electrode regions formed in the piezostack device, alternately in the lamination direction.

### EXAMPLES

### Example 1

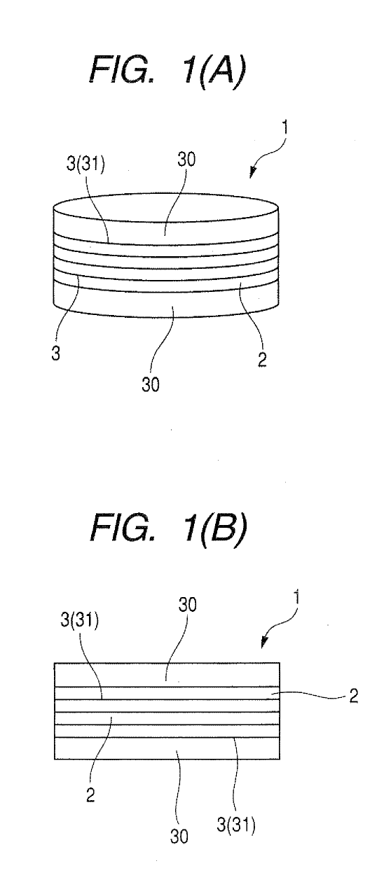

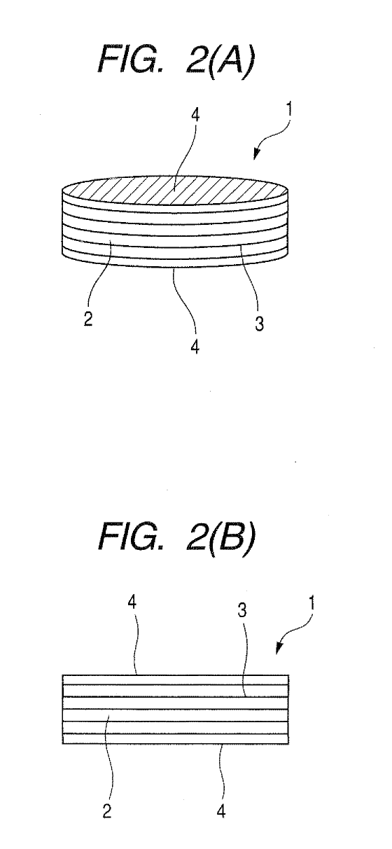

Hereinafter, Examples of the present invention will be described with reference to FIGS. 1 and 2.

In the present Example, as shown in FIGS. 1A and 1B, a piezostack device 1 consisting of piezoelectric ceramic layers 2 made of the crystal-oriented ceramic of polycrystals containing the isotropic perovskite compound as the main phase, in which the crystal faces {100} of the polycrystal crystal grains are oriented, and electrode-containing layers 3 containing electrode regions 31 constituting internal electrodes laminated alternately is prepared by processing in mixing, sheet-forming, printing, laminating and sintering steps.

In the mixing step, a raw material mixture is prepare by mixing an anisotropically shaped powder of anisotropically shaped orientation particles, of which the crystal faces {100} are to be oriented, and a reactive raw powder generating the isotropic perovskite compound in reaction with the anisotropically shaped powder. The anisotropically shaped powder and the reactive raw powder are the mixed in amounts at a stoichiometric ratio giving an isotropic perovskite compound represented by: {Li_{0.059}(K_{0.438}Na_{0.562})_{0.941}}_{1.020}(Nb_{0.84}Ta_{0.099}Sb_{0.061})O₃ from the anisotropically shaped powder and the reactive raw powder after the downstream sintering step, and a Nb₂O₅ powder is mixed therewith in an addition amount of 0.005 to 0.02 mole with respect to 1 mole of the isotropic perovskite compound.

In the sheet-forming step, the raw material mixture is molded into a sheet shape giving a green sheet, in such a manner that the crystal faces {100} of the anisotropically shaped powder particles are oriented almost unidirectionally.

In the printing step, an electrode material is printed on the green sheet, to give the electrode regions after sintering.

In the laminating step, the green sheets after the printing step are laminated into a laminate sheet.

In the sintering step, the laminate sheet is heated, to give the piezostack device.

Hereinafter, the method of producing a piezostack device in the present Example will be described in detail.

### <Mixing Step>

First, an anisotropically shaped powder is prepared. In the present Example, an acid hydrolysate obtained by acid treatment of an anisotropically shaped starting material of the bismuth layered perovskite compound represented by Bi_{2.5}Na_{3.5}(Nb_{0.93}Ta_{0.07})₅O₁₈ (i.e., (Bi₂O₂)²⁺{(Bi_{0.5}Na_{3.5}) (Nb_{0.93}Ta_{0.07})₅O₁₆}²⁻), is used as the anisotropically shaped powder.

Specifically, first, a Bi₂O₃ powder, a NaHCO₃ powder, a Nb₂O₅ powder, and a Ta₂O₅ powder were weighed and subjected to wet mixing at a ratio stoichiometric to Bi_{2.5}Na_{3.5} (Nb_{0.93}Ta_{0.07})₅O₁₈. NaCl was then added thereto as flux in an amount of 80 wt parts with respect to 100 wt parts of the mixture obtained, and the mixture was agitated in the dry state for 1 hour.

The mixture obtained is then sintered in a platinum crucible at a temperature of 1100° C. for 2 hours, to give Bi_{2.5}Na_{3.5}(Nb_{0.93}Ta_{0.07})₅O₁₈. The sintering is carried out at a programmed heating rate of 150° C./h from room temperature to 850° C. and at a heating rate of 100° C./h from 850° C. to 1100° C. It is then cooled at a cooling rate of 150° C./h, and the reaction product is washed with warm water, for removal of the flux, to give a Bi_{2.5}Na_{3.5}(Nb_{0.93}Ta_{0.07})₅O₁₈ powder. The Bi_{2.5}Na_{3.5}(Nb_{0.93}Ta_{0.07})₅O₁₈ powder was a plate-shaped powder having the {001} face as the orientation face (maximum face).

Subsequently, the Bi_{2.5}Na_{3.5}(Nb_{0.93}Ta_{0.07})₅O₁₈ powder was pulverized in a jet mill. After pulverization, the Bi_{2.5}Na_{3.5}(Nb_{0.93}Ta_{0.07})₅O₁₈ powder had an average particle diameter of approximately 12 μm and an aspect ratio of approximately 10 to 20 μm.

Subsequently, 30 ml of 6 N HCl was added to 1 g of the starting raw powder (Bi_{2.5}Na_{3.5}(Nb_{0.93}Ta_{0.07})₅O₁₈ powder) in a beaker, and the mixture was agitated at a temperature of 60° C. for 94 hours. The solid was then filtered under reduce pressure. The acid washing step was repeated twice, to give an acid hydrolysate of Bi_{2.5}Na_{3.5}(Nb_{0.93}Ta_{0.07})₅O₁₈ powder.

Component analysis of the anisotropically shaped powder by using energy dispersive X-Ray inspection apparatus (EDX) and crystalline phase identification by using a X-ray diffractograph (XRD) showed that the anisotropically shaped powder contains a Na_{0.5}(Nb_{0.93}Ta_{0.07})O₃ powder as principal component and had a mixed structure of a perovskite compound and a bismuth layered compound. The anisotropically shaped powder was a plate-shaped powder having an average particle diameter of approximately 12 μm and an aspect ratio of approximately 10 to 20 μm.

A reactive raw powder was then prepared in the following manner:

First, a NaHCO₃ powder, a KHCO₃ powder, a Li₂CO₃ powder, a Nb₂O₅ powder, a Ta₂O₅ powder and a NaSbO₃ powder, all commercially available, were weighed to a composition calculated by subtracting 0.05 mole of the Formula Na_{0.5}(Nb_{0.93}Ta_{0.07})O₃, which is used as the anisotropically shaped powder, from 1 mole of the composition {Li_{0.059}(K_{0.438}Na_{0.562})_{0.941}}_{1.020}(Nb_{0.84}Ta_{0.099}Sb_{0.061})O₃.

Specifically, they were weighed to a composition stoichiometrically corresponding to {Li_{0.06}(K_{0.45} Na_{0.55})_{0.94}}_{1.047}(Nb_{0.835}Ta_{0.1}Sb_{0.065})O₃.

The mixture was then wet-agitated together with an organic solvent as medium by using ZrO₂ balls for 20 hours. Then, the mixture was sintered at 750° C. for 5 hours and wet-pulverized again with an organic solvent as the medium by using ZrO₂ balls or 20 hours, to give a sintered powder (reactive raw powder) having an average particle diameter of approximately 0.5 μm.

The anisotropically shaped powder thus prepared and the reactive raw powder were weighed at a stoichiometric ratio giving a composition of {Li_{0.059}(K_{0.438}Na_{0.562})_{0.941}}_{1.020}(Nb_{0.84}Ta_{0.099}Sb_{0.061})O₃, and a Nb₂O₅ powder was added thereto as additive, to give a raw material mixture (mixing step). Specifically, the anisotropically shaped powder and the reactive raw powder were weighed at a molar ratio of 0.05:0.95 (anisotropically shaped powder: reactive raw powder) and an additive Nb₂O₅ powder was added in an amount of 0.01 mole.

After weighing, the mixture was wet-blended together with an organic solvent as medium by using ZrO₂ balls for 20 hours, to give a raw material mixture slurry. A binder (polyvinylbutyral) and a plasticizer (dibutyl phthalate) were then added to the slurry, and the mixture was agitated additionally. The binder and the plasticizer were added in amounts respectively of 8.0 g (binder) and 4.0 g (plasticizer) with respect to 100 g of the raw material mixture (powder component). In this way, a slurry of the raw material mixture was prepared.

### <Sheet-Forming Step>

Subsequently, the mixed slurry-state raw material mixture was molded into a sheet having a thickness 100 μm in a doctor blade apparatus, to give a green sheet. The anisotropically shaped powder could be oriented almost unidirectionally in the green sheet, for example, by the shearing stress applied to the anisotropically shaped powder.

### <Printing Step>

Subsequently, an AgPd alloy powder containing Pd at 30 mole % was prepared. The AgPd alloy powder and the reactive raw powder described above were mixed at a volume ratio of 9:1, and ethylcellulose and terpineol were added thereto, to give a paste-state electrode material. The electrode material was printed in the regions of the green sheet where electrode regions are to be formed. In the present Example, an electrode material was printed on the entire surface of the two piezoelectric ceramic layers 2, forming an electrode region 31 in the piezostack device 1 obtained after sintering, as described below (see FIGS. 1A and 1B).

### <Laminating Step>

The green sheets carrying the printed electrode material were the laminated and pressed, to give a laminate sheet containing five electrode material-printed layers (electrode-containing layer after sintering) and having a thickness in the lamination direction of 1.2 mm. During lamination, green sheets carrying no printed electrode material were placed at both ends of the laminate sheet in the lamination direction. The green sheets give dummy layers 30 after sintering (see FIGS. 1A and 1B).

The laminate sheet was then heated at a temperature for 400° C. for de-waxing (also called degreasing or debinding) thereof.

### <Sintering Step>

The laminate sheet after de-waxed was then placed on a Pt plate in magnesia container and heated in air at a temperature of 1120° C. for 2 hours, and then cooled to room temperature, to give a piezostack device. The piezostack device obtained was then machine-processed into a disk having a diameter of 7.5 mm and a thickness (height) of 0.7 mm, thus giving a piezostack device 1 having piezoelectric ceramic layers 2 of crystal-oriented ceramic and full-area electrode regions 31 of Ag/Pd alloy (electrode-containing layer 3) that are laminated alternately. It was designated as sample E1. The heating was carried out at a heating rate 200° C./h, and the cooling at a cooling rate of 10° C./h in the temperature range of 1120° C. to 1000° C. and of 200° C./h in the temperature range of 1000° C. or lower.

The final composition of the crystal-oriented ceramic of piezoelectric ceramic layer 2 in sample E1 calculated from the composition and blending ratio of the anisotropically shaped powder, the reactive raw powder and the Nb₂O₅ powder is {Li_{0.059}(K_{0.438}Na_{0.562})_{0.941}}(Nb_{0.843}Ta_{0.097}Sb_{0.06})O₃.

The composition the anisotropically shaped powder and the reactive raw powder used in preparation of sample E1, the addition amount of the Nb₂O₅ powder, the desired composition of the anisotropically shaped powder and the reactive raw powder during mixing in the mixing step, and the composition of the perovskite compound after sintering are summarized in Table 1 below.

The bulk density of the piezostack device (sample E1) was determined then.

Specifically, the weight of the piezostack device when dry (dry weight) was determined. Subsequently, the piezostack device was immersed in water, allowing penetration of water into the openings, and the weight of the piezostack device (water-containing weight) was determined. The volume of the open voids present in the piezostack device was then calculated from the difference between the water-containing weight and the dry weight Separately, the volume of the piezostack device in the region without the open voids was determined by Archimedes method. The bulk density of the piezostack device was calculated then by dividing the dry weight of the piezostack device by the total volume (sum of the open void volume and the volume without the open voids). The results are summarized in Table 1 below.

The orientation degree of the piezoelectric ceramic layer in the piezostack device (sample E1) was also determined.

Specifically, the face (polishing face) perpendicular to the lamination direction of the piezostack device was polished, and the average orientation degree F (100) of the {100} face of the polished face was determined by Lotgering method, by using the Numerical Formula 1 described above. The polished face is formed at a position 100 to 200 μm deeper than the sintered surface and separated from the internal electrode by 100 to 200 μm. The results are summarized in Table 1 below.

The displacement characteristics of the piezostack device (sample E1) were then tested.

Specifically, first, counter electrodes 4 were formed on both ends of the piezostack device 1 in the lamination direction by Au vapor deposition (see FIGS. 2A and 2B).

The piezostack device 1 was immersed in a silicone oil at a temperature of 100° C. and polarized in the silicone oil, while an electric field of 2 kV/mm was applied to the counter electrode 4 for 20 minutes.

The displacement amount ΔL (m) when an electric field of 2 kV/mm was applied between counter electrodes 4 on the piezostack device 1 after polarization at room temperature was determined then. The dynamic strain D₃₃ (mV) was then calculated by the following Formula A. The results are summarized in Table 1 below.

D₃₃=ΔL/L/EF (Formula A)

In Formula A, D₃₃: dynamic strain (m/V), EF: maximum electric field strength (Vim), L the length (m) of the piezostack device in the lamination direction that was held between the counter electrodes before application of voltage

Also in the present Example, a piezostack device (sample C1) was prepared to compare to the sample E1, except that no Nb₂O₅ powder was added in the mixing step of mixing the anisotropically shaped powder and the reactive raw powder. In preparation of the sample C1, the reactive raw material composition was changed from that of sample E1 so that the rate of A site/B site in the crystal-oriented ceramic constituting the piezoelectric ceramic layer in the piezostack device finally obtained becomes identical with that of the sample E1 (A site/B site=1).

Specifically in preparation of the sample C1, first, an anisotropically shaped powder was prepared, in a similar manner to the sample E1.

A NaHCO₃ powder, a KHCO₃ powder, a Li₂CO₃ powder, a T₂O₅ powder, a Ta₂O₅ powder and a NaSbO₃ powder, all commercially available, were weighed in stoichiometric amounts to give a composition of {Li_{0.06}(K_{0.45}Na_{0.55})_{0.94}}_{1.026}(Nb_{0.835}Ta_{0.1}Sb_{0.065})O₃. The mixture was then wet-mixed with an organic solvent as medium by using ZrO₂ balls for 20 hours, similarly to the sample E1. The mixture was then sintered at 750° C. for 5 hours and wet pulverized again with an organic solvent as medium by using ZrO₂ balls for 20 hours, to give a sintered powder (a reactive raw powder) having an average particle diameter of approximately 0.5 μm.

Similarly to sample E1 above, the anisotropically shaped powder and the reactive raw powder were weighed at a molar ratio of 0.05:0.95 (anisotropically shaped powder: reactive raw powder).

Similarly to sample E1 above, the weighed mixture was wet-mixed with an organic solvent as medium and a binder and a plasticizer were added thereto, to give a slurry-state raw material mixture.

The raw material mixture was processed in the printing, laminating and sintering steps, similarly to the sample E1, to give a piezostack device. It was designated as sample C1.

The composition of the anisotropically shaped powder and reactive raw powder used in preparation of the sample C1, the addition amount of the Nb₂O₅ powder, the desired composition when the anisotropically shaped powder and the reactive raw powder are mixed the mixing step, and the composition of the perovskite compound after sintering are summarized in Table 1 below.

The composition after sintering, the bulk density, the average orientation degree, and the dynamic strain D₃₃ of the sample C1 were also determined, similarly to the sample E1. The results are summarized in Table 1.

TABLE 1

| | | | | Desired composition of |
|---|---|---|---|---|
| | | | | the mixture of |
| | | | Nb₂O₅ | anisotropically shaped |
| Sam- | Composition of | Composition of | addition | powder and reactive |
| ple | anisotropically | reactive raw | amount | raw powder in the |
| No. | shaped powder | powder | (mol) | mixing step |
| Sam- | Na_{0.5}(Nb_{0.93}Ta_{0.07})O₃ | {Li_{0.06}(K_{0.45}Na_{0.05})_{0.94}}_{1.047}(Nb_{0.835}Ta_{0.1}Sb_{0.065})O₃ | 0.01 | {Li_{0.059}(K_{0.438}Na_{0.562})_{0.941}}_{1.020}(Nb_{0.84}Ta_{0.099}Sb_{0.061})O₃ |
| ple | | | | |
| E1 | | | | |
| Sam- | Na_{0.5}(Nb_{0.93}Ta_{0.07})O₃ | {Li_{0.06}(K_{0.45}Na_{0.55})_{0.94}}_{1.026}(Nb_{0.835}Ta_{0.1}Sb_{0.065})O₃ | 0 | {Li_{0.059}(K_{0.438}Na_{0.562})_{0.941}}(Nb_{0.84}Ta_{0.099}Sb_{0.061})O₃ |
| ple | | | | |
| C1 | | | | |

| | Composition of | | | |
|---|---|---|---|---|
| | perovskite | Bulk | Orientation | |
| Sample | compound after | density | degree | D33 |
| No. | sintering | (g/cm³) | (%) | (pm/V) |
| Sample | {Li_{0.059}(K_{0.438}Na_{0.562})_{0.941}}(Nb_{0.843}Ta_{0.097}Sb_{0.06})O₃ | 4.77 | 93 | 503 |
| E1 | | | | |
| Sample | {Li_{0.059}(K_{0.438}Na_{0.562})_{0.941}}(Nb_{0.84}Ta_{0.099}Sb_{0.061})O₃ | 4.77 | 88 | 464 |
| C1 | | | | |

As obvious from Table 1, sample E1 prepared by mixing the anisotropically shaped powder, the reactive raw powder and the Nb₂O₅ powder in the mixing step had an orientation degree of the piezoelectric ceramic layer of crystal-oriented ceramic higher than that of the sample C1 prepared without using the Nb₂O₅ powder, indicating improvement in dynamic strain D₃₃. Ail piezoelectric ceramic layers in respective samples showed similar high density.

The results show that addition of the Nb₂O₅ powder in the mixing step is effective in improving the orientation degree of the crystal-oriented ceramic in the piezoelectric ceramic layer and the displacement characteristics of the piezostack device.

Also in the present Example, the piezoelectric ceramic layers of crystal-oriented ceramic were prepared by using sample E1 prepared with the Nb₂O₅ powder blended and sample C1 prepared without the Nb₂O₅ powder blended that are similar in composition and also in the ratio of A site to B site (A/B=1). There was significant difference in orientation degree although, and the orientation degree of the crystal-oriented ceramic in sample E1 was improved, compared with that of sample C1 (see Table 1). The results show that the improvement in orientation degree by blending of the Nb₂O₅ powder is not induced by the change in A site/B site ratio by addition, but by the blending of the Nb₂O₅ powder itself.

### Example 2

In the present Example, described is preparation of a piezostack device by mixing the anisotropically shaped powder and the reactive raw powder in the mixing step, in a composition different from that of the samples E1 and C1 of Example 1. In the present Example, the anisotropically shaped powder and the reactive raw powder are mixed in the mixing step in stoichiometric amounts giving a composition of {Li_{0.059}(K_{0.438}Na_{0.5622})_{0.941}}_{0.975}(Nb_{0.84}Ta_{0.099}Sb_{0.061})O₃.

Specifically, first, an anisotropically shaped powder (Na_{0.5}(Nb_{0.93}Ta_{0.07})O₃ powder) is prepared, in a similar manner to Example 1. Then, a NaHCO₃ powder, a KHCO₃ powder, a Li₂CO₃ powder, a Nb₂O₅ powder, a Ta₂O₅ powder and a NaSbO₃ powder, all commercially available, were weighed to a composition calculated by subtracting 0.05 mole of the Formula Na_{0.5}(Nb_{0.93}Ta_{0.07})O₃, which is used as the anisotropically shaped powder, from 1 mole of the composition {Li_{0.059}(K_{0.438}Na_{0.562})_{0.941}}_{0.975}(Nb_{0.84}Ta_{0.099}Sb_{0.061})O₃. Specifically, the NaHCO₃ powder, the KHCO₃ powder, the Li₂CO₃ powder, the Nb₂O₅ powder, the Ta₂O₅ powder and the NaSbO₃ powder were weighed to a composition stoichiometrically corresponding to {Li_{0.06}(K_{0.45}Na_{0.55})_{0.94}} (Nb_{0.835}Ta_{0.1}Sb_{0.065})O₃.

The mixture was then sintered and wet-pulverized, similarly to Example 1, to give a sintered powder (reactive raw powder) having an average particle diameter of approximately 0.5 μm.

Subsequently, the anisotropically shaped powder thus obtained and the reaction raw material were weighed to a composition stoichiometrically corresponding to {Li_{0.059}(K_{0.438}Na_{0.562})_{0.941}}_{0.975}(Nb_{0.84}Ta_{0.099}Sb_{0.061})O₃, and the Nb₂O₅ powder was added as an additive. Specifically, the anisotropically shaped powder and the reaction raw material were weighed at a molar ratio of 0.05:0.95 (anisotropically shaped powder:reaction raw material) and, a Nb₂O₅ powder was added as additive in an amount of 0.005 mole.

After weighing, in a similar manner to Example 1, the mixture was wet-blended with an organic solvent as the medium and a binder and a plasticizer were added and mixed, to give a slurry-state raw material mixture.

The raw material mixture was then processed in the sheet-forming, printing, laminating and sintering steps, similarly to Example 1, to give a disk-shaped piezostack device. It was designated as sample E2.

The final composition of the crystal-oriented ceramic in the piezoelectric ceramic layer of sample E2 is considered to be {Li_{0.0059}(K_{0.438}Na_{0.562})_{0.941}}_{0.965}(Nb_{0.841}Ta_{0.098}Sb_{0.061})O₃, from the compositions and the blending ratio of the anisotropically shaped powder, the reactive raw powder and the Nb₂O₅ powder.

The composition of the anisotropically shaped powder and the reactive raw powder used in preparation of sample E2, the addition amount of the Nb₂O₅ powder, the desired composition of the anisotropically shaped powder and the reactive raw powder during mixing in the mixing step, and the composition of the perovskite compound after sintering are summarized in Table 2 below.

Also in the present Example, four kinds of piezostack devices, which are different from sample E2 in the amount of the Nb₂O₅ powder added when the anisotropically shaped powder and the reactive raw powder are mixed, were prepared additionally (samples E3, E4, C2 and C3).

These samples were prepared, similarly to sample E2 above, except that the amount of the Nb₂O₅ powder added was different.

The composition of the anisotropically shaped powder and the reactive raw powder used in preparation of each sample (sample E2 to sample E4, sample C2, or sample C3), the amount of the Nb₂O₅ powder added, the desired composition of the anisotropically shaped powder and the reactive raw powder when mixed in the mixing step, and the composition of the perovskite compound after sintering are summarized in Table 2 below.

The bulk density, the average orientation degree and the dynamic strain D₃₃ of these samples were also determined, in a similar manner to Example 1. The results are also summarized in Table 2.

TABLE 2

| | | | | Desired composition |
|---|---|---|---|---|
| | Composition | | | of the mixture of |
| | of | | Nb₂O₅ | anisotropically |
| | anisotropically | Composition of | addition | shaped powder and |
| Sample | shaped | reactive raw | amount | reactive raw powder |
| No. | powder | powder | (mol) | in the mixing step |
| Sample E2 | Na_{0.5}(Nb_{0.93}Ta_{0.07})O₃ | {Li_{0.06}(K_{0.45}Na_{0.05})_{0.94}}(Nb_{0.835}Ta_{0.1}Sb_{0.065})O₃ | 0.005 | {Li_{0.059}(K_{0.438}Na_{0.562})_{0.941}}_{0.975}(Nb_{0.84}Ta_{0.099}Sb_{0.061})O₃ |
| Sample | Na_{0.5}(Nb_{0.93}Ta_{0.07})O₃ | {Li_{0.06}(K_{0.45}Na_{0.55})_{0.94}}(Nb_{0.835}Ta_{0.1}Sb_{0.065})O₃ | 0.01 | {Li_{0.059}(K_{0.438}Na_{0.562})_{0.941}}_{0.975}(Nb_{0.84}Ta_{0.099}Sb_{0.061})O₃ |
| E3 | | | | |
| Sample | Na_{0.5}(Nb_{0.93}Ta_{0.07})O₃ | {Li_{0.06}(K_{0.45}Na_{0.55})_{0.94}}(Nb_{0.835}Ta_{0.1}Sb_{0.065})O₃ | 0.02 | {Li_{0.059}(K_{0.438}Na_{0.562})_{0.941}}_{0.975}(Nb_{0.84}Ta_{0.099}Sb_{0.061})O₃ |
| E4 | | | | |
| Sample | Na_{0.5}(Nb_{0.93}Ta_{0.07})O₃ | {Li_{0.06}(K_{0.45}Na_{0.55})_{0.94}}(Nb_{0.835}Ta_{0.1}Sb_{0.065})O₃ | 0 | {Li_{0.059}(K_{0.438}Na_{0.562})_{0.941}}_{0.975}(Nb_{0.84}Ta_{0.099}Sb_{0.061})O₃ |
| C2 | | | | |
| Sample | Na_{0.5}(Nb_{0.93}Ta_{0.07})O₃ | {Li_{0.06}(K_{0.45}Na_{0.55})_{0.94}}(Nb_{0.835}Ta_{0.1}Sb_{0.065})O₃ | 0.04 | {Li_{0.059}(K_{0.438}Na_{0.562})_{0.941}}_{0.975}(Nb_{0.84}Ta_{0.099}Sb_{0.061})O₃ |
| C3 | | | | |

| | Composition of | | | |
|---|---|---|---|---|
| | perovskite | Bulk | Orientation | |
| Sample | compound after | density | degree | D33 |
| No. | sintering step | (g/cm³) | (%) | (pm/V) |
| Sample E2 | {Li_{0.059}(K_{0.438}Na_{0.562})_{0.941}}_{0.965}(Nb_{0.841}Ta_{0.098}Sb_{0.061})O₃ | 4.76 | 96 | 521 |
| Sample | {Li_{0.059}(K_{0.438}Na_{0.562})_{0.941}}_{0.956}(Nb_{0.843}Ta_{0.097}Sb_{0.06})O₃ | 4.77 | 98 | 532 |
| E3 | | | | |
| Sample | {Li_{0.059}(K_{0.438}Na_{0.562})_{0.941}}_{0.938}(Nb_{0.846}Ta_{0.095}Sb_{0.059})O₃ | 4.79 | 90 | 497 |
| E4 | | | | |
| Sample | {Li_{0.059}(K_{0.438}Na_{0.562})_{0.941}}_{0.975}(Nb_{0.84}Ta_{0.099}Sb_{0.061})O₃ | 4.76 | 89 | 484 |
| C2 | | | | |
| Sample | {Li_{0.059}(K_{0.438}Na_{0.562})_{0.941}}_{0.903}(Nb_{0.852}Ta_{0.091}Sb_{0.057})O₃ | 4.80 | 72 | 370 |
| C3 | | | | |

As obvious from Table 9, even in producing a piezostack device having a piezoelectric ceramic layer of crystal-oriented ceramic different in composition from Example 1, it is possible to raise the orientation degree and increase the dynamic strain D₃₃ of the crystal-oriented ceramic constituting the piezoelectric ceramic layer if the Nb₂O₅ powder is added in an amount of 0.005 mole to 0.02 mole when the anisotropically shaped powder and the reactive raw powder are mixed (sample E2 to sample E4), compared to the sample prepared without using the Nb₂O₅ powder (sample C2). All of the piezoelectric ceramic layers of samples E2 to E4 had a density not lower than that of sample C2.

On the other hand, addition of the Nb₂O₅ powder in a relatively large amount (0.04 mole) (see sample C3) rather lead to deterioration in the orientation degree and the dynamic strain D₃₃ of the piezostack device.

Therefore, the addition amount of the Nb₂O₅ powder is found to be preferably 0.005 to 0.02 mole, more preferably 0.005 to 0.015 mole, with respect to 1 mole of the isotropic perovskite compound.

### Example 3

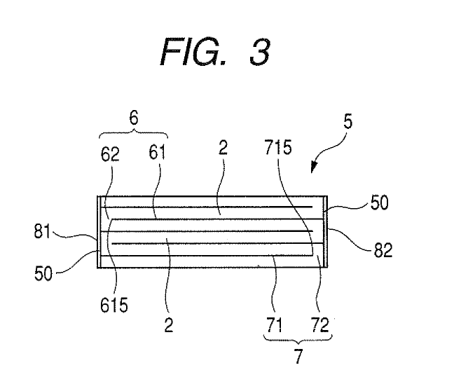

In the present Example, the piezostack device 5 of the present Example, which is an example of the piezostack device having a local electrode as electrode region and an external electrode on the side wall, is prepared by alternately laminating piezoelectric ceramic layers 2 and electrode-containing layers 6 and 7 having electrode regions 61 and 71 constituting the internal electrodes, as shown in FIG. 3. The electrode-containing layers 6 and 7 have respectively electrode regions 61 and 71 and non-electrode-containing regions 62 and 72 enclosed by the external surface terminals 615 and 715 of the electrode regions 61 and 71, as they recede from the external surface side wall 50 of the piezostack device inward by a particular distance. Strictly speaking, the non-electrode-containing regions 62 and 72 are not in the layer state but are the regions where the crystal-oriented ceramics in the two piezoelectric ceramic layers 2 holding the non-electrode-containing regions 62 and 72 inside in the lamination direction are connected to each other during sintering, and thus, are made of the crystal-oriented ceramic identical with that of the piezoelectric ceramic layer 2. In the present description, the regions from the external surface terminals 615 and 715 of the electrode regions 61 and 71 to the side wall 50 of the piezostack device 1 located almost on the same plane with the electrode regions 61 and 71 in the electrode-containing layers 6 and 7 are called non-electrode-containing regions 62 and 72, for convenience.

A pair of external electrodes 81 and 82 is formed on the external surface side wall 50 of the piezostack device 5, and the electrode regions 61 and 71 of two neighboring electrode-containing layers 6 and 7 in the lamination direction are respectively electrically connected to the different external electrodes 81 and 82.

In the present Example, the piezoelectric ceramic layer 2 is made of a crystal-oriented ceramic similar to that of Example 1 or sample E1.

Hereinafter, a method of producing the piezostack device in the present Example will be described.

First, a green sheet was prepared by processing in the mixing and sheet-forming steps, similarly to the sample E1 of Example 1. Then similarly to Example 1, an AgPd alloy powder containing Pd at 30 mole % and a reactive raw powder were mixed at a volume ratio 9:1; ethylcellulose and terpineol were added thereto, to give a paste-state electrode material; and the electrode material was printed on a green sheet in the region where an electrode region is formed.

In the present Example too, an electrode material was printed in such a manner that electrode regions 61 and 71 and non-electrode-containing regions 62 and 72 enclosed by the external surface terminals 615 and 715 and receding from the external surface side wall 50 of the piezostack device 1 inward by a particular distance are formed between the piezoelectric ceramic layers in the piezostack device 1 obtained after sintering described below (see FIG. 3).

The green sheets were then laminated and pressed, so that the non-electrode-containing regions 62 and 72 were located on the side walls different from each other. In this way, a laminate sheet containing five electrode material layers (electrode-containing layers after sintering) and having a thickness of 1.2 mm in the lamination direction was prepared. Then similarly to Example 1, the laminate sheet was heated at a temperature of 400° C. for de-waxing thereof.

It is then processed in the sintering step, in a similar manner to Example 1. In this way, a piezostack device 5 similar in composition to Example 1 and having the piezoelectric ceramic layers 2 of crystal-oriented ceramic and the electrode-containing layers 6 and 7 laminated alternately was obtained.

A pair of external electrodes 81 and 82 was then formed on the side wall 50 of the piezostack device 5. The external electrodes 81 and 82 were formed by baking an Ag paste containing glass components. The pair of external electrodes 81 and 82 is respectively connected to one of the electrode regions 61 and 72 in the neighboring two electrode-containing layers 6 and 7 in the piezostack device 5.

A piezostack device 1 was prepared in this way.

As shown in FIG. 3, the piezostack device 5 in the present Example has piezoelectric ceramic layers 2 and electrode-containing layers 6 and 7 laminated alternately; and the electrode-containing layers 6 and 7 have electrode regions 61 and 71 constituting conductive internal electrodes and non-electrode-containing regions 62 and 72 enclosed by the external surface terminals 615 and 715 of the electrode regions 61 and 71 that recede from the external surface side wall 50 of the piezostack device 5 inward by a particular distance. Accordingly, the piezostack device 5 has, when seen in the lamination direction, a piezoelectrically active region where all electrode regions 61 and 71 are polymerized and a piezoelectrically inactive region where at least part of or all of the electrode regions 61 and 71 are not polymerized. A pair of external electrodes 81 and 82 holding it are formed on the side wall 50 of the piezostack device 5; the external electrodes 81 and 82 are electrically connected to neighboring two internal electrodes (electrode regions 61 and 71) alternately in the piezostack device 5. Therefore, if voltage is applied to the external electrodes, each piezoelectric ceramic 2 held between the internal electrodes 61 and 71 is deformed by so-called (reverse) piezoelectric effect in the lamination direction of the ceramic laminate sheet. Thus, the piezostack device 5 as a whole shows large displacement. In particular, the piezostack device 5 in the present Example has a piezoelectric ceramic layer 2 higher in orientation degree and superior in displacement characteristic, similar to the sample E1 of Example 1, and can show superior displacement characteristic, as each piezoelectric ceramic layer 2 show its superior displacement characteristic.

What is claimed is:

1. A method of producing a piezostack device having piezoelectric ceramic layers of a crystal-oriented ceramic of polycrystals including an isotropic perovskite compound as a main phase, in which crystal faces {100} of crystal grains constituting the polycrystals are oriented, and electrode-containing layers including electrode regions constituting internal electrodes laminated alternately, comprising:
a mixing step of mixing an anisotropically shaped powder only of anisotropically shaped orientation particles, of which the crystal faces {100} are to be oriented, and a reactive raw powder giving the isotropic perovskite compound in reaction with the anisotropically shaped powder, to give a raw material mixture;
a sheet-forming step of molding the raw material mixture into a sheet shape, so that the crystal faces {100} of the anisotropically shaped powder particles are oriented almost unidirectionally, to give a green sheet;
a printing step of printing the electrode region on the green sheet after sintering thereof with an electrode material;
a laminating step of laminating the green sheets ater the printing step into a laminate sheet; and
a sintering step of obtaining a piezostack device having piezoelectric ceramic layers of the crystal-oriented ceramic and the electrode-containing layers including the electrode regions laminated alternately by allowing reaction between the anisotropically shaped powder and the reactive raw powder and sintering the mixture by heating the laminate sheet, wherein,
in the mixing step, the anisotropically shaped powder and the reactive raw powder are mixed in amounts at a stoichiometric ratio giving an isotropic perovskite compound represented by General Formula (1): {Liₓ(K_{1-y}Na_{y})₁₋ₓ}ₐ(Nb_{1-Z-w}Ta_{z}Sb_{w})O₃, (wherein, 0≦x≦0.2, 0≦y≦1, 0≦z≦0.4, 0≦w≦0.2 x+z+w>0, and 0.95≦a≦1) from the anisotropically shaped powder and the reactive raw powder after the sintering step, and a Nb₂O₅ powder and/or a Ta₂O₅ powder are mixed in an addition amount of 0.005 to 0.02 mol with respect to 1 mole of the isotropic perovskite compound represented by the General Formula (1).

2. The method of producing a piezostack device according to claim 1, wherein the anisotropically shaped powder used is an acid hydrolysate obtained by acid treatment of an anisotropically shaped starting material of a bismuth layered perovskite compound represented by General Formula (2): (Bi₂O₂)²⁺{Bi_{0.5}(KᵤNa₁₋ᵤ)_{m-1.5}(Nb₁₋ᵥTaᵥ)ₘO₃ₘ₊₁}²⁻, (wherein, m is an integer of 2 or more, 0≦u≦0.8, and 0≦v≦0.4).

3. The method of producing a piezostack device according to claim 1, wherein the reactive raw powder used is a powder of an isotropic perovskite compound represented by General Formula (3): {Liₚ(K_{1-q}Na_{q})₁₋ₚ}_{c}(Nb₁₋ᵣ₋ₛTaᵣSbₛ)O₃, (wherein, 0≦p≦1, 0≦q≦1, 0≦r≦1, 0≦s≦1, and 0.95≦c≦1.05).

4. The method of producing a piezostack device according to claim 1, wherein, in the General Formula (1), the relationships of 9x−5z−17w≧−318 and −18.9x−3.9z−5.8w−130 are satisfied.
